(19) United States
(12) Patent Application Publication
(10) Pub. No.: US 2026/0300159 A1
(43) Pub. Date: Oct. 1, 2026

(54) DECODING METHOD AND ASSOCIATED FLASH MEMORY CONTROLLER AND MEMORY DEVICE

(71) Applicant: Silicon Motion, Inc., Hsinchu County (TW)

(72) Inventors: Mao-Ruei Li, Hsinchu City (TW); Duen-Yih Teng, Hsinchu County (TW)

(73) Assignee: Silicon Motion, Inc., Hsinchu County (TW)

(21) Appl. No.: 19/093,294

(22) Filed: Mar. 28, 2025

(51) Int. Cl. G06F 12/02

(52) U.S. Cl. CPC G06F 12/0246

(57) ABSTRACT

The present invention provides a decoding method, which includes steps of: receiving data from a flash memory module; generating syndromes corresponding to the data according to the data and a parity check matrix; storing decoding information corresponding to only a portion of the data into a memory; iteratively updating the syndromes and the decoding information stored in the memory until the updated syndromes meet a specific condition; and generating decoded data according to the updated syndromes and the updated decoded information.

### BACKGROUND OF THE INVENTION

### 1. Field of the Invention

The present invention relates to a flash memory controller.

### 2. Description of the Prior Art

LDPC (Low-Density Parity-Check) encoding and decoding methods have been widely used in flash memory for efficient encoding and decoding operations. However, in LDPC decoders, multiple iterations are typically required to generate the decoded data. When the size of data to be decoded is large or the error rate of the data to be decoded is high, it can affect the decoding rate of the decoder, thereby impacting the overall performance.

### SUMMARY OF THE INVENTION

Therefore, one of the objectives of the present invention is to provide a decoder and a related decoding method, which can selectively store information by controlling the memory in the decoder, thereby reducing the number of iterations and increasing the decoding rate of the decoder, in order to solve the issues described in the prior art.

According to one embodiment of the present invention, a decoding method comprises steps of: receiving data from a flash memory module; generating syndromes corresponding to the data according to the data and a parity check matrix; storing decoding information corresponding to only a portion of the data into a memory; iteratively updating the syndromes and the decoding information stored in the memory until the updated syndromes meet a specific condition; and generating decoded data according to the updated syndromes and the updated decoded information.

According to one embodiment of the present invention, a flash memory controller is disclosed. The flash memory controller is used to access a flash memory module, and the flash memory controller comprises a read-only memory configured to store a program code, a microprocessor configured to execute the program code to control access of the flash memory module, an encoder and a decoder. The decoder is configured to perform steps of: receiving data from the flash memory module; generating syndromes corresponding to the data according to the data and a parity check matrix; storing decoding information corresponding to only a portion of the data into a memory; iteratively updating the syndromes and the decoding information stored in the memory until the updated syndromes meet a specific condition; and generating decoded data according to the updated syndromes and the updated decoded information.

According to one embodiment of the present invention, a memory device comprising a flash memory module and a flash memory controller is disclosed. The flash memory controller is configured to perform the steps of: receiving data from the flash memory module; generating syndromes corresponding to the data according to the data and a parity check matrix; storing decoding information corresponding to only a portion of the data into a memory; iteratively updating the syndromes and the decoding information stored in the memory until the updated syndromes meet a specific condition; and generating decoded data according to the updated syndromes and the updated decoded information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory device according to an embodiment of the present invention.

FIG. 2 shows a parity check matrix and a parity generation matrix.

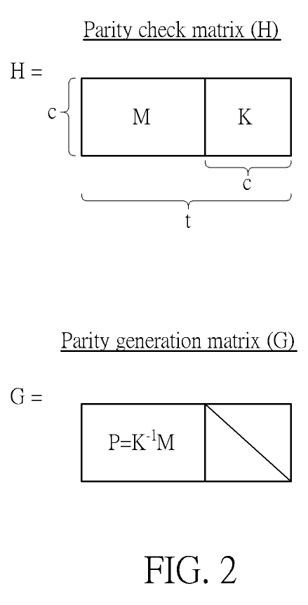

FIG. 3 is a diagram illustrating a decoder according to one embodiment of the present invention.

FIG. 4 is a diagram showing that the decoding information corresponding to columns with low column weight is not stored in the memory.

FIG. 5 is a flowchart of a decoding method according to one embodiment of the present invention.

### DETAILED DESCRIPTION

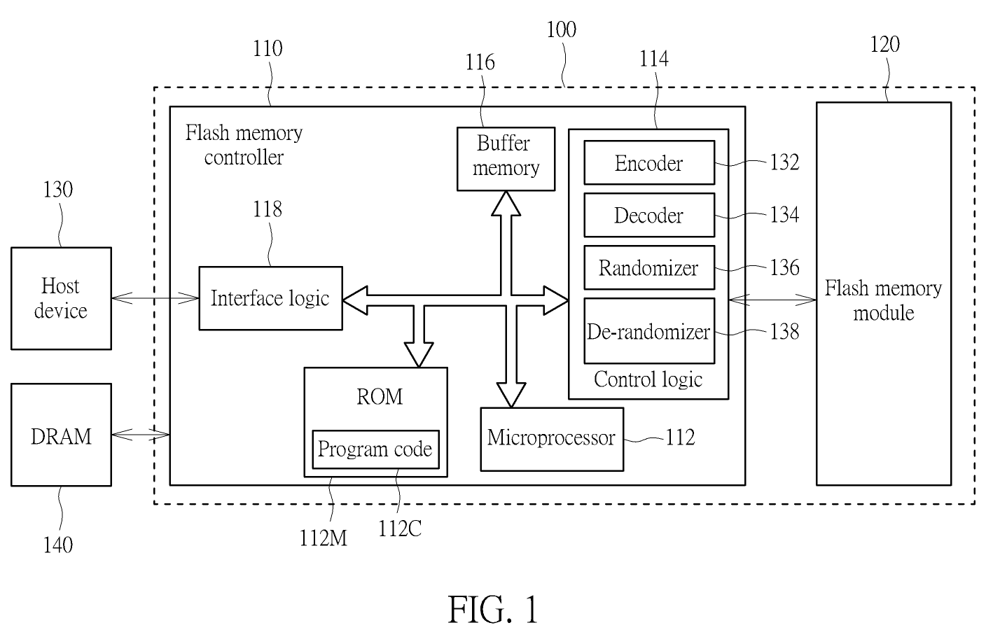

FIG. 1 is a diagram illustrating a memory device 100 according to an embodiment of the present invention. The memory device 100 includes a flash memory module 120 and a flash memory controller 110, wherein the flash memory controller 110 is arranged to access the flash memory module 120. The flash memory controller 110 includes a microprocessor 112, a read only memory (ROM) 112M, a control logic 114, a buffer memory 116 and an interface logic 118. The ROM 112M is arranged to store a program code 112C, and the microprocessor 112 is arranged to execute the program code 112C to control access of the flash memory module 120. The control logic 114 includes an encoder 132, a decoder 134, a randomizer 136 and a de-randomizer 138. The encoder 132 is arranged to encode data that is written into the flash memory module 120 to generate a corresponding parity (also known as an error correction code (ECC)), and the decoder 134 is arranged to decode data that is read from the flash memory module 120. The randomizer 136 is used to randomize the data written to the flash memory module 120, and the de-randomizer 138 is used to de-randomize the data read from the flash memory module 120.

In a general situation, the flash memory module 120 includes a plurality of flash memory chips, and each flash memory chip includes a plurality of blocks. A controller (e.g. the flash memory controller 110 that executes the program code 112C through the microprocessor 112) may copy, erase, and merge data for the flash memory module 120 with a block as a unit. In addition, a block can record a specific number of pages, wherein the controller (e.g. the flash memory controller 110 that executes the program code 112C through the microprocessor 112) may perform a data write operation upon the flash memory module 120 with a page as a unit. In other words, a block is the smallest erase unit in the flash memory module 120, and a page is the smallest write unit in the flash memory module 120.

In practice, the flash memory controller 110 that executes the program code 112C through the microprocessor 112 may utilize its own internal components to perform many control operations. For example, the flash memory controller 122 utilizes the control logic 114 to control access of the flash memory module 120 (more particularly, access at least one block or at least one page), utilizes the buffer memory 116 and/or a DRAM 140 to perform a required buffering operation, and utilizes the interface logic 118 to communicate with a host device 130.

In one embodiment, the memory device 100 may be a portable memory device such as a memory card which conforms to one of the SD/MMC, CF, MS and XD specifications, and the host device 130 is an electronic device able to be connected to the memory device 100, such as a cellphone, a laptop, a desktop computer, etc. In another embodiment, the memory device 100 can be a solid state drive (SSD) or an embedded storage device conforming to the universal flash storage (UFS) or embedded multi-media card (EMMC) specifications, and can be arranged in an electronic device. For example, the memory device 100 can be arranged in a cellphone, a watch, a portable medical testing device (e.g. a medical wristband), a laptop, or a desktop computer. In this case, the host device 130 can be a processor of the electronic device.

In this embodiment, the flash memory module 120 is a three-dimensional (3D) NAND-type flash memory, in which each block is composed of multiple word lines, multiple bit lines and multiple memory cells. Since the 3D NAND flash memory architecture is well known to those with ordinary knowledge in the art, no further explanation is given in the specification.

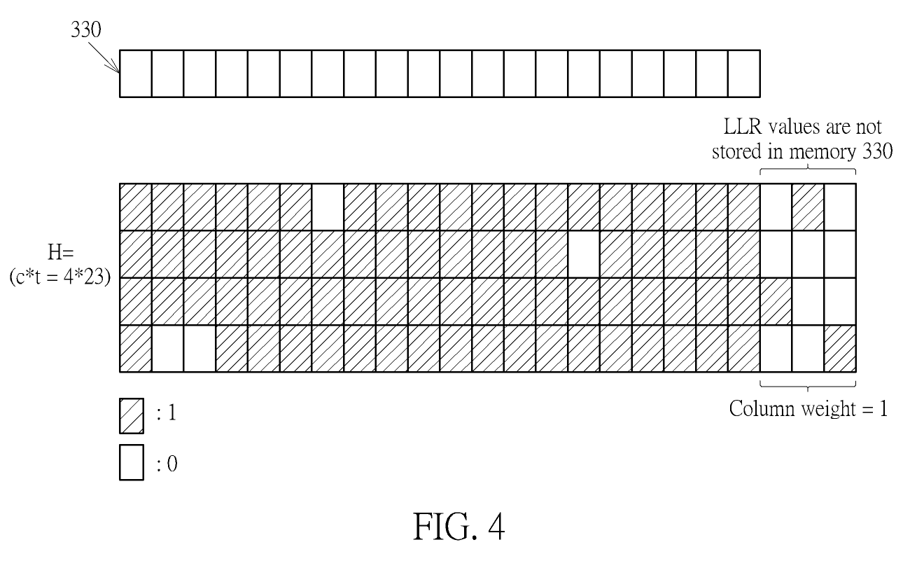

The encoder 132 is a LDPC encoder, which encodes data from the host device 130 to generate at least one codeword (i.e., the encoded data), and store the codeword into the flash memory module 120. Then, if the flash memory controller 110 receives a read command from the host device 130, the decoder 134 will decode data (i.e., the codeword) read from the flash memory module 130 to generate decoded data. Specifically, the encoder 132 has a parity check matrix and a parity generation matrix, wherein the parity generation matrix is used to multiply data, such as 4 kilo-type (KB) data, to generate the corresponding codeword (the codeword comprises 4KB data and corresponding parity (also named as ECC)); and the parity check matrix is used to check whether the codeword generated by the encoder 132 is correct. For example, after the encoder 132 encodes the 4KB data to generate the corresponding codeword, the 4KB data with the parity will be multiplied by the parity-check matrix, to generate a multiplication result. If the multiplication result is equal to “0”, it is determined that the encoding is correct; and if the multiplication result is not equal to “0”, it is determined that the encoding is incorrect. The parity generation matrix and the parity check matrix have a specific relationship. FIG. 4 is a diagram illustrating a concept of the parity check matrix and parity generation matrix according to one embodiment of the present invention. As shown in FIG. 4, the parity check matrix is a c*t matrix, and the parity check matrix can be divided into a left-side c*(t-c) matrix M and a right-side c*c matrix K. In order to find out the parity generation matrix corresponding to the parity check matrix, an inverse matrix K⁻¹ of the matrix K may be found out first. Afterwards, the inverse matrix K⁻¹ is multiplied by the matrix M to generate a matrix P, and a transpose matrix of the matrix P with an identity matrix can act as the parity generation matrix. In other words, the encoder 132 can multiply 4KB data from the host device 130 by the transpose matrix of the matrix P with the identity matrix to obtain the codeword corresponding to the 4KB data, and multiply the codeword by the parity check matrix to determine whether the encoding is correct. In addition, regarding the operation of the decoder 134, the data read from the flash memory module 130 is multiplied with the parity check matrix, and use an iteration operation to update the corresponding information of the data, until a multiplication result of the data and the parity check matrix is equal to “0”.

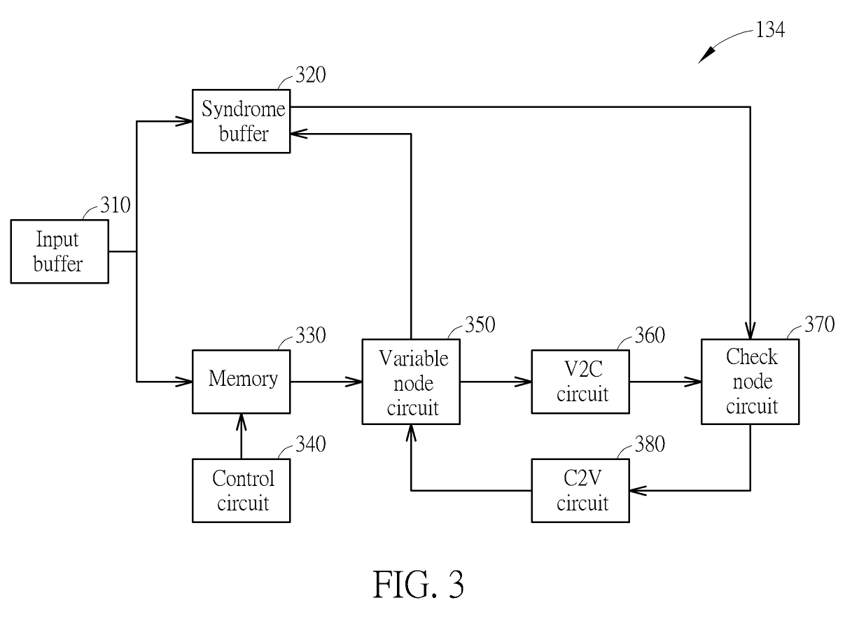

FIG. 3 is a diagram illustrating the decoder 134 according to one embodiment of the present invention. As shown in FIG. 3, the decoder 134 comprises an input buffer 310, a syndrome buffer 320, a memory 330, a control circuit 340, a variable node circuit 350, a variable node to check node (V2C) circuit 360, a check node circuit 370 and a check node to variable node (C2V) circuit 380. The input buffer 350 is configured to store the data read from the flash memory module 130, wherein the data may be 4KB data or data with another size. The decoder 130 calculates the syndromes by multiplying the data with the parity check matrix, and the syndromes are stored in the syndrome buffer 320. In the LDPC decoding, the syndrome is used to check how well the received data satisfies the parity-check equations defined by parity check matrix, and if one or more syndromes are non-zero, it indicates the presence of errors that need to be corrected; and if all the syndromes are zero, it indicates that the data is valid, and no errors exist. In addition, the decoder 134 determines decoding information of at least a portion of bits of the data, such as Log-Likelihood Ratio (LLR) values, and stores these LLR values into the memory 330.

The variable node circuit 350, V2C circuit 360, check node circuit 370 and C2V circuit 380 are configured to generate/update internal values in each iteration in the decoding steps, to update syndromes stored in the syndrome buffer 320 and LLR values stored in the memory 330. Specifically, in the bipartite graph representation of the LDPC code, the graph consists of two types of nodes: variable nodes and check nodes. The variable nodes represent the bits in the data (i.e., encoded codeword), while check nodes represent the parity-check equations that must be satisfied by the data. Each variable node is connected to one or more check nodes, indicating that the corresponding bit is part of one or more parity-check equations. In the flow of decoding the data, variable nodes work with check nodes to iteratively adjust their values in order to satisfy these parity-check equations. There are two common decoding algorithms for LDPC codes that define the update mechanism for variable nodes and check nodes: the Sum-Product Algorithm (SPA) and the Min-Sum Algorithm.

It is noted that the operations of updating syndromes, LLR values, variable node values and check node values are known by a person skilled in the art, and the present invention focuses on the control of the memory 330, so the detailed description about the variable node circuit 350, V2C circuit 360, check node circuit 370 and C2V circuit 380 are omitted here.

In the operation of the decoder 134, if the parity check matrix has one or more columns having low column weight, the LLR values corresponding to these columns having low column weight are usually not updated during the iterations of the decoding steps. Therefore, this embodiment provides the control circuit 340 which can control the memory 330 to only the LLR values corresponding to the columns not having low column weight, to save the memory space and lower the iterations of the decoding steps. Specifically, in the parity check matrix, each column corresponds to a bit, each row represents a parity-check equation, the column weight refers to the number of "1"s in a given column, meaning how many parity-check equations involve this bit. Taking FIG. 4 as an example, it is assumed that the size of parity check matrix is 4*23, the first column has column weight “4”, the second column has column weight “3” , the third column has column weight “3”, …, and each of the last three columns has column weight “1”. The “low column weight” can be defined as column weight lower than a threshold value. In this embodiment, the “low column weight” indicates that the column weight is equal to one.

It is noted that the size of parity check matrix shown in FIG. 4 is for illustrative only, not a limitation of the present invention. In practice, the column number of the parity check matrix is equal to size of data to be decoded.

In this embodiment, the control circuit 340 records the locations of the columns having low column weight, and during the decoding operation, the decoding information corresponding to the columns with low column weight is not stored in the memory 330. Taking FIG. 4 as an example, the memory 330 only stores the LLR values corresponding to the first twenty columns in the parity check matrix, and the decoding information (e.g., LLR values) of the last three columns is always not stored in the memory 330.

In addition, since LLR values corresponding to the columns with lower column weight are not generated or updated, the calculation load of the decoder 134 will also be reduced. Taking FIG. 4 as an example, the last three columns are directly ignored, so the decoder 134 only requires 76 cycles in each iteration, wherein the syndromes and LLR values corresponding to the first twenty columns of the parity check matrix are updated once in one iteration of decoding step.

In addition, the syndromes and the decoding information stored in the memory 330 are iteratively updated until the updated syndromes meet a specific condition, for example, until the updated syndromes are equal to zero. Then, the decoder 134 can generate decoded data according to the updated syndromes and the updated LLR values.

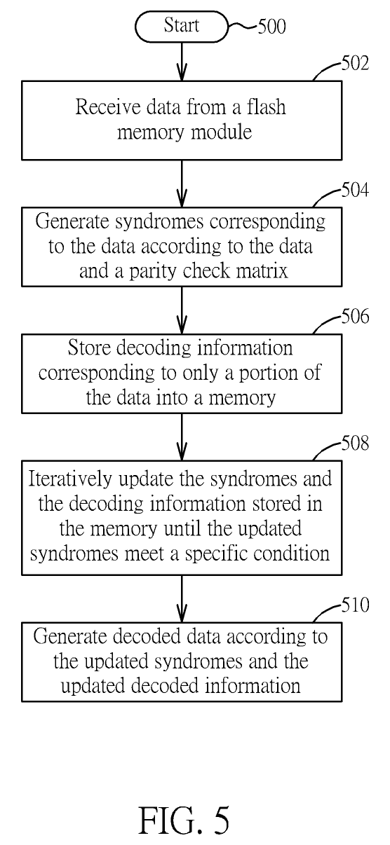

FIG. 5 is a flowchart of a decoding method according to one embodiment of the present invention. Referring to the above embodiments together, the flow of decoding method is described as follows.

Step 500: the flow starts.

Step 502: receive data from a flash memory module.

Step 504: generate syndromes corresponding to the data according to the data and a parity check matrix.

Step 506: store decoding information corresponding to only a portion of the data into a memory.

Step 508: iteratively update the syndromes and the decoding information stored in the memory until the updated syndromes meet a specific condition.

Step 510: generate decoded data according to the updated syndromes and the updated decoded information.

In the flowchart shown in FIG. 5, the step of storing decoding information corresponding to only the portion of the data into the memory comprises: storing the decoding information corresponding to columns not having low column weight into the memory; and not storing the decoding information corresponding to columns having the low column weight into the memory. In addition, the decoding information corresponding to columns having the low column weight is never updated during a decoding process of the data. In one embodiment, the decoding information comprises LLR values.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A decoding method, comprising:
receiving data from a flash memory module;
generating syndromes corresponding to the data according to the data and a parity check matrix;
storing decoding information corresponding to only a portion of the data into a memory;
iteratively updating the syndromes and the decoding information stored in the memory until the updated syndromes meet a specific condition; and
generating decoded data according to the updated syndromes and the updated decoded information.

2. The decoding method of claim 1, wherein the step of storing decoding information corresponding to only the portion of the data into the memory comprises:
storing the decoding information corresponding to columns not having low column weight of the parity check matrix into the memory; and
not storing the decoding information corresponding to columns having the low column weight of the parity check matrix into the memory.

3. The decoding method of claim 2, wherein the column weight refers to a number of "1"s in the column of the parity check matrix, and the low column weight indicates that the column weight is lower than a threshold value.

4. The decoding method of claim 3, wherein the low column weight indicates that the column weight is equal to one.

5. The decoding method of claim 2, wherein the decoding information corresponding to columns having the low column weight is never updated during a decoding process of the data.

6. The decoding method of claim 1, wherein the decoding information corresponding to only the portion of the data comprises Log-Likelihood Ratio (LLR) values corresponding to only the portion of the data.

7. A flash memory controller, wherein the flash memory controller is used to access a flash memory module, and the flash memory controller comprises:
a read-only memory, configured to store a program code;
a microprocessor, configured to execute the program code to control access of the flash memory module;
an encoder; and
a decoder;
wherein the decoder is configured to perform steps of:
receiving data from the flash memory module;
generating syndromes corresponding to the data according to the data and a parity check matrix;
storing decoding information corresponding to only a portion of the data into a memory;
iteratively updating the syndromes and the decoding information stored in the memory until the updated syndromes meet a specific condition; and
generating decoded data according to the updated syndromes and the updated decoded information.

8. The flash memory controller of claim 7, wherein the step of storing decoding information corresponding to only the portion of the data into the memory comprises:
storing the decoding information corresponding to columns not having low column weight of the parity check matrix into the memory; and
not storing the decoding information corresponding to columns having the low column weight of the parity check matrix into the memory.

9. The flash memory controller of claim 8, wherein the column weight refers to a number of "1"s in the column of the parity check matrix, and the low column weight indicates that the column weight is lower than a threshold value.

10. The flash memory controller of claim 9, wherein the low column weight indicates that the column weight is equal to one.

11. The flash memory controller of claim 8, wherein the decoding information corresponding to columns having the low column weight is never updated during a decoding process of the data.

12. The flash memory controller of claim 7, wherein the decoding information corresponding to only the portion of the data comprises Log-Likelihood Ratio (LLR) values corresponding to only the portion of the data.

13. A memory device, comprising:
a flash memory module;
a flash memory controller, configured to access the flash memory module;
wherein the flash memory controller is configured to perform the steps of:
receiving data from the flash memory module;
generating syndromes corresponding to the data according to the data and a parity check matrix;
storing decoding information corresponding to only a portion of the data into a memory;
iteratively updating the syndromes and the decoding information stored in the memory until the updated syndromes meet a specific condition; and
generating decoded data according to the updated syndromes and the updated decoded information.

14. The memory device of claim 13, wherein the step of storing decoding information corresponding to only the portion of the data into the memory comprises:
storing the decoding information corresponding to columns not having low column weight of the parity check matrix into the memory; and
not storing the decoding information corresponding to columns having the low column weight of the parity check matrix into the memory.

15. The memory device of claim 14, wherein the column weight refers to a number of "1"s in the column of the parity check matrix, and the low column weight indicates that the column weight is lower than a threshold value.

16. The memory device of claim 15, wherein the low column weight indicates that the column weight is equal to one.

17. The memory device of claim 14, wherein the decoding information corresponding to columns having the low column weight is never updated during a decoding process of the data.

18. The memory device of claim 13, wherein the decoding information corresponding to only the portion of the data comprises Log-Likelihood Ratio (LLR) values corresponding to only the portion of the data.
